(19) United States
(12) Patent Application Publication
(10) Pub. No.: US 2016/0330616 A1
(43) Pub. Date: Nov. 10, 2016

(54) WIRELESS COMMUNICATION SYSTEM, COMMUNICATION TERMINAL, SECURITY MANAGEMENT SERVER, DEVICE MANAGEMENT SERVER, AND WIRELESS COMMUNICATION METHOD THEREIN

(71) Applicant: APLIX IP HOLDINGS CORPORATION, Tokyo (JP)

(72) Inventors: Ryu Koriyama, Tokyo (JP); Takahiro Shirakawa, Saitama (JP)

(73) Assignee: APLIX IP HOLDINGS CORPORATION, Tokyo (JP)

(21) Appl. No.: 15/215,232

(22) Filed: Jul. 20, 2016

Related U.S. Application Data
(63) Continuation of application No. PCT/JP2015/050429, filed on Jan. 9, 2015.

(30) Foreign Application Priority Data
Jan. 23, 2014 (JP) 2014-010557

(51) Int. Cl. H04W 12/02; H04L 29/06; H04L 9/32; H04M 1/725; H04W 8/02

(52) U.S. Cl. CPC H04W 12/02; H04M 1/7253; H04W 8/02; H04L 9/3247; H04L 63/0492; H04L 2209/80

(57) ABSTRACT

Data is safely transmitted or received between an electronic device and a communication terminal. The electronic device having a wireless communication capability transmits data, which is encrypted using a predetermined cryptographic key, to the communication terminal, and decrypts data, which is transmitted from the communication terminal, using the predetermined cryptographic key. The communication terminal capable of wirelessly communicating with the electronic device transfers encrypted data to or from the electronic device, and requests a security management server to encrypt or decrypt data. The security management server encrypts or decrypts data, which is transmitted from the communication terminal, using the predetermined cryptographic key, and transmits the data to the communication terminal.

### TECHNICAL FIELD

The present invention relates to a wireless communication system. More particularly, the present invention is concerned with a wireless communication system, a communication terminal, a security management server, and a device management server for enhancing security, and a wireless communication method in them.

### BACKGROUND ART

Along with prevalence of a communication terminal, a system in which the communication terminal and an electronic device are connected to each other, and the communication terminal receives and utilizes information sent from the electronic device has been put to use. For example, a system in which the communication terminal has acquired the information from the electronic device and further transmits it to a cloud computer to thereby receive a service has been proposed (refer to, for example, patent literature 1 to 3).

### CITATION LIST

### Patent Literature

PTL 1: Japanese Unexamined Patent Application Publication No. 2013-182279

PTL 2: Japanese Unexamined Patent Application Publication No. 2013-191917

PTL 3: Japanese Unexamined Patent Application Publication No. 2013-191918

### SUMMARY OF INVENTION

### Technical Problem

In the above related arts, the electronic device incorporates a communication system LSI to thereby connect to the communication terminal through wireless communication and enable the communication terminal to receive a service. However, in direct wireless communication between the electronic device and the communication terminal, there is a security vulnerability problem such that, for example, a type of the electronic device is easily identified in return for improved convenience. In addition, if the information acquired from the electronic device is grasped based on the contents of wireless communication, it is confronted with a problem that the privacy of a user is impaired.

The present invention addresses the foregoing situation. An object of the invention is to safely transmit or receive data between an electronic device and a communication terminal.

### Solution to Problem

The present invention is intended to solve the foregoing problems. A first aspect of the invention is concerned with a wireless communication system including an electronic device that has a wireless communication capability, a communication terminal capable of wirelessly communicating with the electronic device, and a security management server that manages security of data which is transmitted or received between the electronic device and the communication terminal, the communication terminal, the security management server, and a wireless communication method. In the wireless communication system, the electronic device transmits data, which is encrypted using a predetermined cryptographic key, to the communication terminal, and decrypts data, which is transmitted from the communication terminal, using the predetermined cryptographic key. The security management server encrypts or decrypts data, which is transmitted from the communication terminal, using the predetermined cryptographic key, and transmits the data to the communication terminal. The communication terminal transfers encrypted data to or from the electronic device, and requests the security management server to encrypt or decrypt data.

A second aspect of the present invention is concerned with a wireless communication system including an electronic device that has a wireless communication capability, a communication terminal capable of wirelessly communicating with the electronic device, and a device management server that manages information on the electronic device, the communication terminal, the device management server, and a wireless communication method. In the wireless communication system, the electronic device transmits or receives data to or from the communication terminal. The device management server converts data, which is transmitted from the communication terminal, into a format in which data can be processed by an application running on the communication terminal, or a format in which data can be processed by the electronic device, on the basis of the information on the electronic device. The communication terminal requests the device management server to convert data, which is transmitted from the electronic device, into the format in which data can be processed by the application running on the communication terminal, and requests the device management server to convert data, which is transmitted to the electronic device, into the format in which data can be processed by the electronic device.

### Advantageous Effect of Invention

The present invention can exert an excellent advantageous effect that data can be safely transmitted or received between an electronic device and a communication terminal.

### BRIEF DESCRIPTION OF DRAWINGS

FIG. 1 is a diagram showing an example of an overall configuration of a wireless communication system in embodiments of the present invention.

FIG. 2 is a diagram showing an example of hardware configurations of a communication terminal 100 and an electronic device 200 in the embodiments of the present invention.

FIG. 3 is a diagram showing an example of a software configuration of the communication terminal 100 in the embodiments of the present invention.

FIG. 4 is a diagram showing an example of a path of data along which data is transmitted from the electronic device 200 to the communication terminal 100 in a first embodiment of the present invention.

FIG. 5 is a diagram showing an example of a path of data along which data is transmitted from the communication terminal 100 to the electronic device 200 in the first embodiment of the present invention.

FIG. 6 is a flowchart describing an example of a processing sequence for encryption in the embodiments of the present invention.

FIG. 7 is a diagram showing an example of data transition in processing steps of encryption shown in FIG. 6.

FIG. 8 is a flowchart describing an example of a processing sequence for decryption in the embodiments of the present invention.

FIG. 9 is a diagram showing an example of a path of data along which data is transmitted from the electronic device 200 to the communication terminal 100 in a second embodiment of the present invention.

FIG. 10 is a diagram showing an example of a path of data along which data is transmitted from the communication terminal 100 to the electronic device 200 in the second embodiment of the present invention.

FIG. 11 is a diagram showing an example of a path of data along which data is transmitted from the electronic device 200 to the communication terminal 100 in a third embodiment of the present invention.

FIG. 12 is a diagram showing an example of a path of data along which data is transmitted from the communication terminal 100 to the electronic device 200 in the third embodiment of the present invention.

FIG. 13 is a diagram showing an example of a path of data along which data is transmitted from the electronic device 200 to the communication terminal 100 in a fourth embodiment of the present invention.

FIG. 14 is a diagram showing an example of a path of data along which data is transmitted from the communication terminal 100 to the electronic device 200 in the fourth embodiment of the present invention.

### DESCRIPTION OF EMBODIMENTS

Modes for embodying the present invention (hereinafter, embodiments) will be described below.

Overall Configuration of a Wireless Communication System

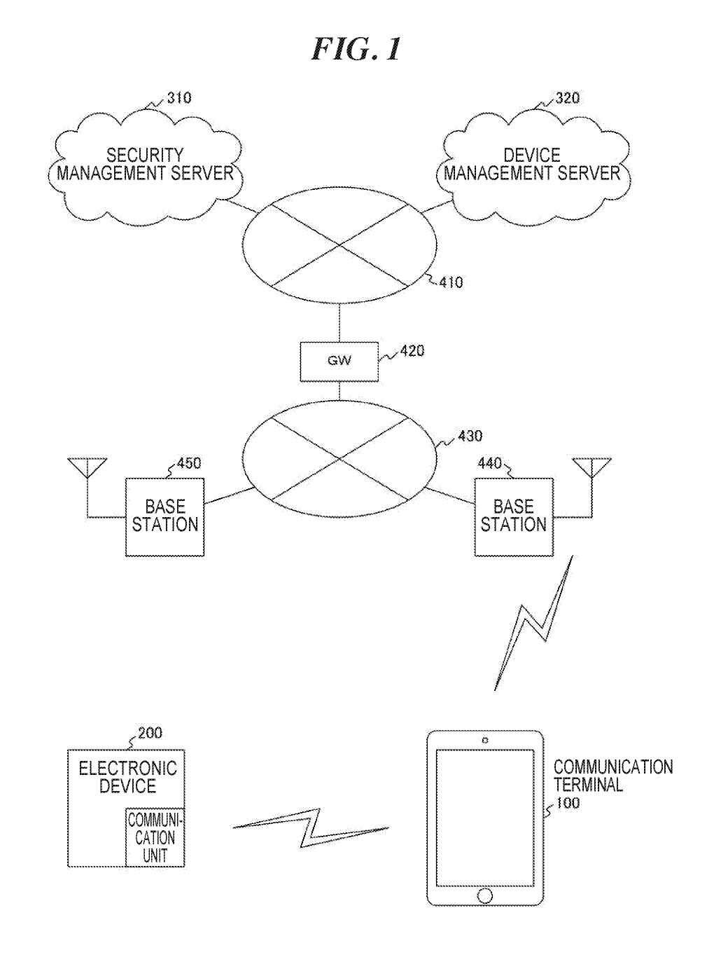

FIG. 1 is a diagram showing an example of an overall configuration of a wireless communication system in embodiments of the present invention. The wireless communication system includes a communication terminal 100, an electronic device 200, a security management server 310, and a device management server 320. The security management server 310 and the device management server 320 are connected to a network 410. A base station 440 or 450 that wirelessly communicates with the communication terminal 100 is connected to a network 430. The network 410 and the network 430 are connected to each other via a gateway (GW) 420. The communication terminal 100 and the electronic device 200 are connected to each other through wireless communication, and data is directly transmitted or received between the communication terminal 100 and the electronic device 200. Paths from the communication terminal 100 to the security management server 310 and the device management server 320 may include a wireless communication channel and a wired communication channel. As for the communication terminal 100 and the electronic device 200, a plurality of communication terminals and a plurality of electronic devices may exist.

The communication terminal 100 is a terminal that includes a user interface through which the communication terminal communicates with a user, accepts an operation input, or performs outputting such as displaying. As the communication terminal 100, for example, a handheld terminal such as a smartphone is conceivable.

The electronic device 200 is a device that is an object of operation by the communication terminal 100. As the electronic device 200, for example, healthcare equipment such as a weight meter or a body composition monitor, household equipment such as a lighting system, and a peripheral such as a headphone are conceivable. However, the present invention is not limited to these devices. The electronic device 200 includes a communication unit and wirelessly communicates with the communication terminal 100, as described later.

The security management server 310 is a server that manages security of data which is transmitted or received between the electronic device 200 and the communication terminal 100. The security management server 310 provides encryption and decryption services. The security management server 310 manages a sequence number SEQ, an electronic signature SIG, and a cryptographic key (common key) Kc that are unique to each electronic device 200.

The device management server 320 is a server that manages information on the electronic device 200. On the basis of the information on the electronic device 200, the device management server 320 renders a service of converting data, which is to be transmitted from the communication terminal 100 to the electronic device 200, into a format in which data can be processed by the electronic device 200. The device management server 320, on the basis of the information on the electronic device 200, renders a service of converting data, which the communication terminal has received from the electronic device 200, into a format in which data can be processed by an application running on the communication terminal 100.

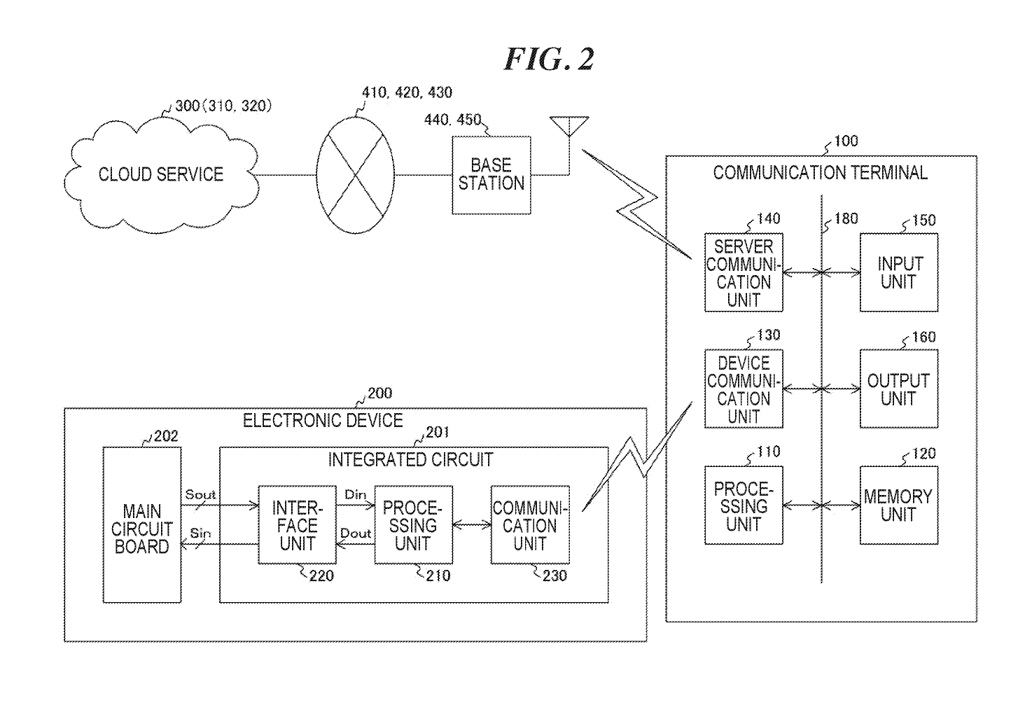

FIG. 2 is a diagram showing an example of hardware configurations of the communication terminal 100 and the electronic device 200 in the embodiments of the present invention. Herein, the security management server 310 and the device management server 320 are generically called a cloud service 300. Communications between the communication terminal 100 and the cloud service 300 are performed using the SLL/TLS protocol or the like, whereby secure connection is guaranteed.

The communication terminal 100 includes a processing unit 110, a memory unit 120, a device communication unit 130, a server communication unit 140, an input unit 150, and an output unit 160. These units are interconnected over a bus 180.

The processing unit 110 is a processor that performs processing in the communication terminal 100. More particularly, the processing unit 110 controls communication of the device communication unit 130 with the electronic device 200 and communication of the server communication unit 140 with the could service 300, and also controls a user interface of each of the input unit 150 and the output unit 160.

The memory unit 120 is a memory that stores appropriate working data which is necessary for the processing unit 110 to perform processing. As the memory unit 120, for example, a memory circuit or an SD memory card is conceivable.

The device communication unit 130 communicates with the electronic device 200. As a communication method in this case, for example, the short-range wireless communication standard such as Bluetooth (registered trademark) Low Energy (BLE) is suitable. However, the present invention is not limited to Bluetooth Low Energy.

The server communication unit 140 communicates with the cloud service 300 via the base station 440 or 450 if necessary. In this case, as the base station 440 or 450, an access point on a wireless LAN under Wi-Fi (registered trademark) or the like or a base station for mobile communications involving cellular phones or the like is conceivable. However, the present invention is not limited to the access point or the base station.

The input unit 150 accepts an input made by a user. As the input unit 150, for example, a tactile sensor on a touch panel is conceivable. An externally connected keyboard or the like may be employed.

The output unit 160 presents information to a user. As the output unit 160, for example, a display of a touch panel is conceivable as to output information to a visual sense. In addition, a loudspeaker may be included as to output voice to an auditory sense.

The electronic device 200 includes an integrated circuit 201 and a main circuit board 202. The main circuit board 202 is a main circuit having the original capabilities of the electronic device 200. Since the integrated circuit 201 having a wireless communication capability is included in addition to the main circuit board 202, data generated on the main circuit board 202 can be transmitted to outside or data can be received from outside.

The integrated circuit 201 includes a processing unit 210, an interface (I/F) unit 220, and a communication unit 230.

The processing unit 210 is a processor that performs processing in the electronic device 200. The processing unit 210 generates data, which is to be transmitted from the communication unit 230, on the basis of digital data Din received from the main circuit board 202 through the interface unit 220, and feeds the data to the communication unit 230. The processing unit 210 generates digital data Dout on the basis of data received by the communication unit 230, and feeds the data to the interface unit 220.

The interface unit 220 transfers data to or from the main circuit board 202. The interface unit 220 converts an analog or digital output signal Sout, which is fed from the main circuit board 202, into the digital data Din that can be processed by the processing unit 210. The interface unit 220 converts the digital data Dout, which is fed from the processing unit 210, into an analog or digital input signal Sin for the main circuit board 202.

The communication unit 230 wirelessly communicates with the communication terminal 100.

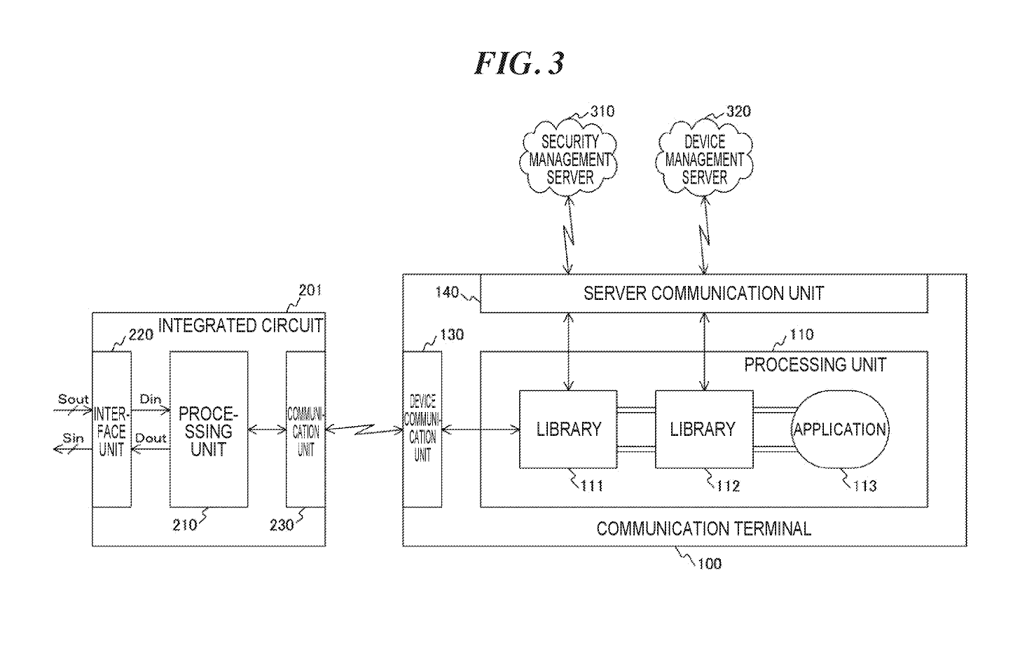

FIG. 3 is a diagram showing an example of a software configuration of the communication terminal 100 in the embodiments of the present invention.

The processing unit 110 runs libraries 111 and 112 and an application 113. The library 110 has the function to transmit or receive data to or from the security management server 310 via the server communication unit 140. The library 112 has the function to transmit or receive data to or from the device management server 320. The application 113 is an application run by the processing unit 110.

### First Embodiment

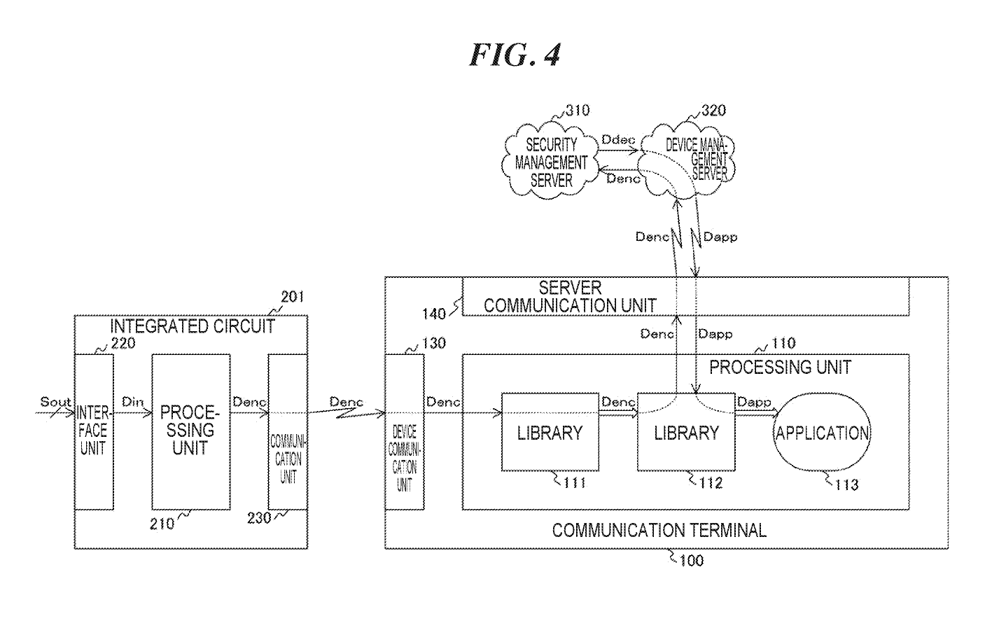

FIG. 4 is a diagram showing an example of a path of data along which data is transmitted from the electronic device 200 to the communication terminal 100 in a first embodiment of the present invention. When seen from the electronic device 200, the data direction is upward or is an uplink or upstream direction. In the first embodiment, access to the security management server 310 is gained via the device management server 320. Therefore, access to the security management server 310 from the library 111 does not take place.

An analog or digital output signal Sout fed from the main circuit board 202 is converted into digital data Din, which can be processed by the processing unit 210, by the interface unit 220. The digital data Din is fed to the processing unit 210.

The digital data Din fed from the interface unit 220 is encrypted using a predetermined cryptographic key by the processing unit 210, and encrypted data Denc is generated. The encrypted data Denc encrypted by the processing unit 210 is transmitted to the communication terminal 100 by the communication unit 230. At this time, the contents of wireless communication between the electronic device 200 and the communication terminal 100 can be intercepted by anybody. However, since data is encrypted, a third party cannot grasp the contents of communication.

The encrypted data Denc transmitted from the electronic device 200 is received by the device communication unit 130, and fed to the library 111. The encrypted data Denc fed to the library 111 is further fed to the library 112. The encrypted data Denc fed to the library 112 is transmitted to the device management server 320 by the server communication unit 140.

The encrypted data Denc transmitted to the device management server 320 is transmitted to the security management server 310. The encrypted data Denc transmitted to the security management server 310 is decrypted using the predetermined cryptographic key by the security management server 310, and decrypted data Ddec is generated. The decrypted data Ddec decrypted by the security management server 310 is transmitted to the device management server 320.

The decrypted data Ddec transmitted to the device management server 320 is converted by the device management server 320 into data Dapp in a format, in which data can be processed by the application 113 running on the communication terminal 100, on the basis of the information on the electronic device 200. The data Dapp converted by the device management server 320 is transmitted to the communication terminal 100.

The data Dapp transmitted from the device management server 320 is received by the server communication unit 140. The data Dapp received by the server communication unit 140 is fed to the library 112. The data Dapp fed to the library 112 is fed to the application 113.

As mentioned above, when data is transmitted from the electronic device 200 to the communication terminal 100 in the first embodiment, the processing unit 210 of the electronic device 200 encrypts the data so as to generate the encrypted data Denc. The encrypted data Denc is fed to the security management server 310 via the communication terminal 100 and the device management server 320. The security management server 310 decrypts the encrypted data Denc so as to generate the decrypted data Ddec. The device management server 320 converts the decrypted data Ddec into the data Dapp in a format, in which data can be processed by the application 113.

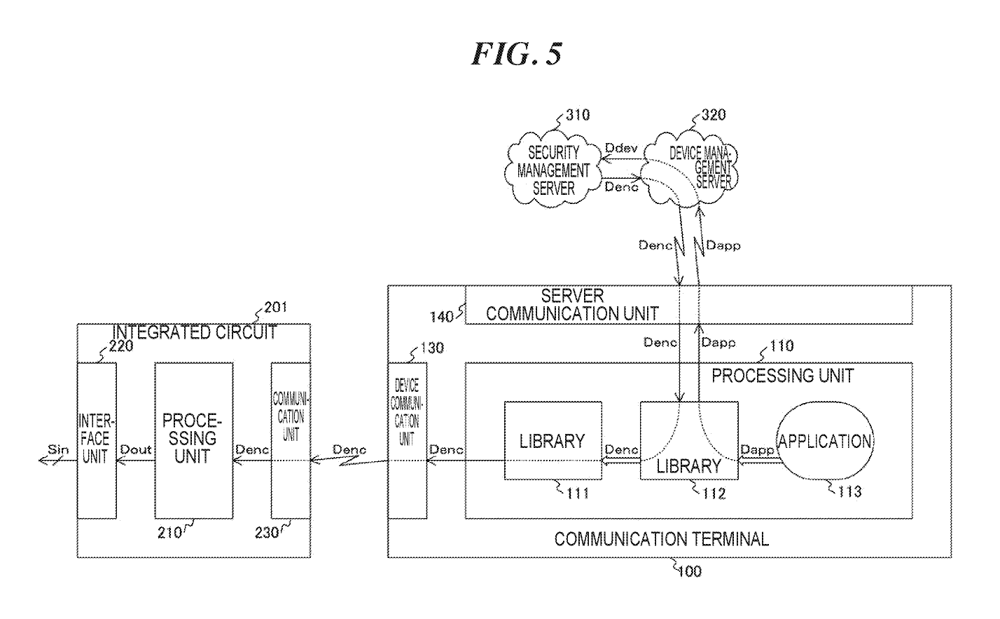

FIG. 5 is a diagram showing an example of a path of data along which data is transmitted from the communication terminal 100 to the electronic device 200 in the first embodiment of the present invention. When seen from the electronic device 200, the data direction is downward or is a downlink or downstream direction.

Data Dapp generated by the application 113 is fed to the library 112. The data Dapp fed to the library 112 is transmitted to the device management server 320 by the server communication unit 140.

The data Dapp transmitted to the device management server 320 is converted by the device management server 320 into data Ddev in a format, in which data can be processed by the electronic device 200. The data Ddev converted by the device management server 320 is transmitted to the security management server 310.

The data Ddev transmitted to the security management server 310 is encrypted using the predetermined cryptographic key by the security management server 310, and encrypted data Denc is generated. The encrypted data Denc encrypted by the security management server 310 is transmitted to the device management server 320. The encrypted data Denc transmitted to the device management server 320 is transmitted to the communication terminal 100.

The encrypted data Denc transmitted from the device management server 320 is received by the server communication unit 140. The encrypted data Denc received by the server communication unit 140 is fed to the library 112. The encrypted data Denc fed to the library 112 is further fed to the library 111. The encrypted data Denc fed to the library 111 is transmitted to the electronic device 200 via the device communication unit 130. At this time, the contents of wireless communication between the communication terminal 100 and the electronic device 200 can be intercepted by anybody. However, since data is encrypted, a third party cannot grasp the contents of communication.

The encrypted data Denc transmitted to the electronic device 200 is received by the communication unit 230. The encrypted data Denc received by the communication unit 230 is fed to the processing unit 210. The encrypted data Denc fed to the processing unit 210 is decrypted using the predetermined cryptographic key by the processing unit 210, and digital data Dout is generated. The digital data Dout decrypted by the processing unit 210 is fed to the interface unit 220.

The digital data Dout fed to the interface unit 220 is converted into an analog or digital input signal Sin for the main circuit board 202 by the interface unit 220. The converted analog or digital input signal Sin is fed to the main circuit board 202.

As mentioned above, when data is transmitted from the communication terminal 100 to the electronic device 200 in the first embodiment, the device management server 320 converts the data into the data Ddev in a format, in which data can be processed by the electronic device 200. The security management server 310 encrypts the converted data Ddev so as to generate the encrypted data Denc. The encrypted data Denc is fed to the electronic device 200 via the communication terminal 100. The processing unit 210 decrypts the encrypted data Denc so as to generate the digital data Dout. The digital data Dout is converted into the input signal Sin for the main circuit board 202 by the interface unit 220.

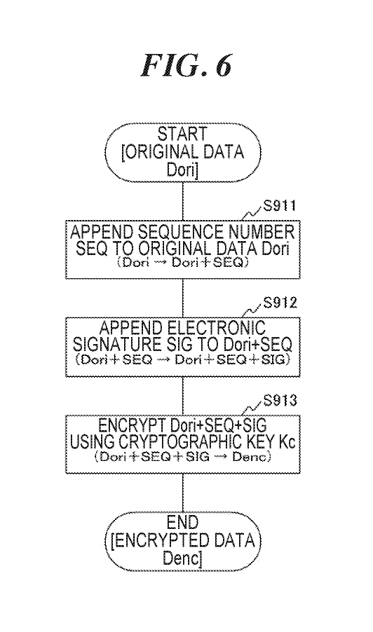

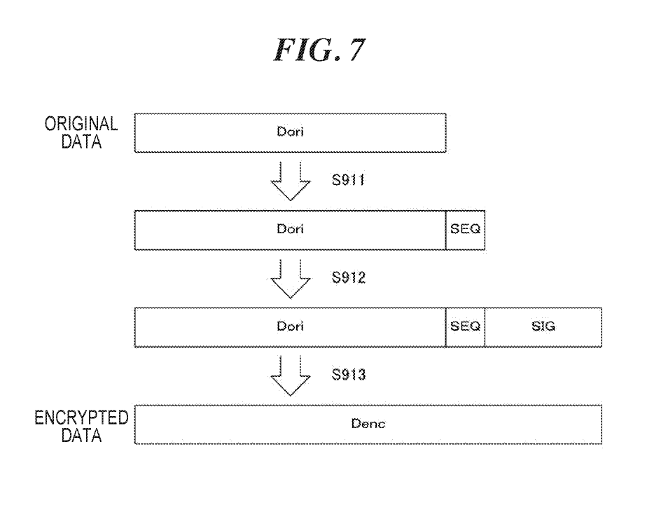

FIG. 6 is a flowchart describing an example of a processing sequence for encryption in the embodiments of the present invention. FIG. 7 is a diagram showing an example of data transition in processing steps of encryption shown in FIG. 6. Herein, plaintext data before encryption is shown as original data Dori. In the first embodiment, the digital data Din in FIG. 4 or the data Ddev in FIG. 5 falls under the original data Dori.

In the first embodiment, when data is transmitted from the electronic device 200 to the communication terminal 100, the processing unit 210 of the electronic device 200 encrypts the data. When data is transmitted from the communication terminal 100 to the electronic device 200, the security management server 310 encrypts the data. Thus, the encrypted data Denc is generated. As mentioned previously, the security management server 310 manages the sequence number SEQ, the electronic signature SIG, and the cryptographic key Kc which are unique to each electronic device 200, and can encrypt data so that the encrypted data can be decrypted by the associated electronic device 200.

In the encryption sequence, first, the sequence number SEQ is appended to the original data Dori (step S911). Every time data is transmitted, the sequence number is incremented. Thus, even when data having the same contents is transmitted a plurality of times, the contents of the encrypted data Denc can be varied every time, and therefore, third party cannot predict the identity with data transmitted previously. By managing the sequence number not only on a data transmitting side but also on a data receiving side, even if a third party impersonates a transmitter to retransmit data, which has been transmitted previously by the transmitter, to a receiver, the receiver can decide that the data is invalid data.

Thereafter, the electronic signature SIG is appended to the original data Dori to which the sequence number SEQ has been appended (step S912). Accordingly, a receiver of encrypted data created by a third party can decide that the data is invalid data. In addition, a man-in-the-middle attack by the third party can be prevented. Then, the data to which the electronic signature SIG is appended is encrypted into the encrypted data Denc using the cryptographic key Kc (step S913).

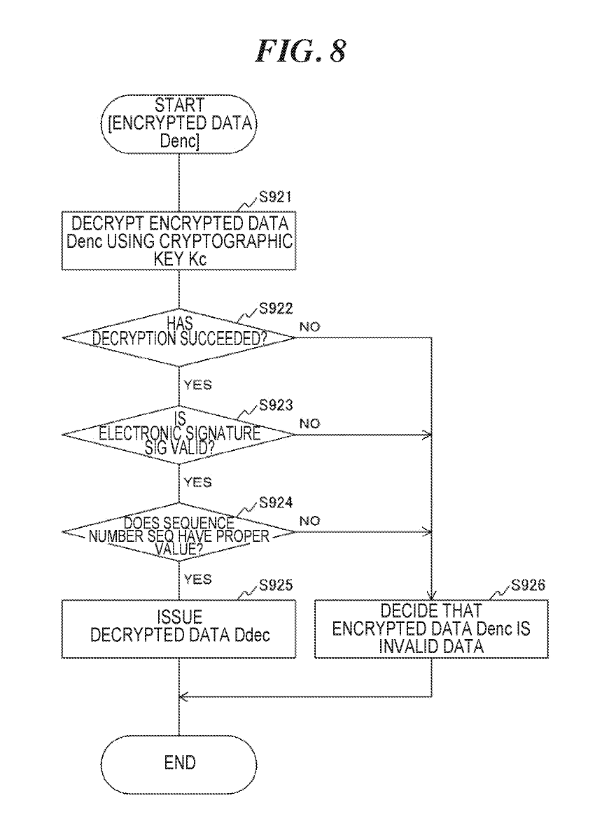

FIG. 8 is a flowchart describing an example of a processing sequence for decryption in the embodiments of the present invention. Herein, the encrypted data Denc shall be decrypted into the decrypted data Ddec. In the first embodiment, the decrypted data Ddec in FIG. 4 or the digital data Dout in FIG. 5 falls under the decrypted data Ddec.

In the first embodiment, when data is transmitted from the electronic device 200 to the communication terminal 100, the security management server 310 decrypts the data. When data is transmitted from the communication terminal 100 to the electronic device 200, the processing unit 210 of the electronic device 200 decrypts the data. Thus, the decrypted data Ddec is generated. As mentioned previously, the security management server 310 manages the sequence number SEQ, the electronic signature SIG, and the cryptographic key Kc which are unique to each electronic device 200, and can decrypt data encrypted by the associated electronic device 200.

In the decryption sequence, first, the encrypted data Denc is decrypted using the cryptographic key Kc (step S921). If decryption of the encrypted data Denc using the cryptographic key Kc has succeeded (step S922: Yes), the electronic signature SIG and the sequence number SEQ contained in the decrypted data are checked (steps S923 and S924).

If the electronic signature SIG is valid (step S923: Yes) and the sequence number SEQ takes on a proper value (step S924: Yes), the data decrypted at step S921 is issued as the decrypted data Ddec (step S925). In contrast, if decryption of the encrypted data Denc using the cryptographic key Kc has failed (step S922: No), if the electronic signature SIG is invalid (step S923: No), or if the sequence number SEQ does not take on a proper value (step S924: No), the encrypted data Denc is decided to be invalid data (step S926), and decrypted data is not issued.

As mentioned above, according to the first embodiment, the communication terminal 100 requests the security management server 310 to encrypt or decrypt data via the device management server 320, whereby the data can be safely transmitted or received between the electronic device 200 and the communication terminal 100.

### Second Embodiment

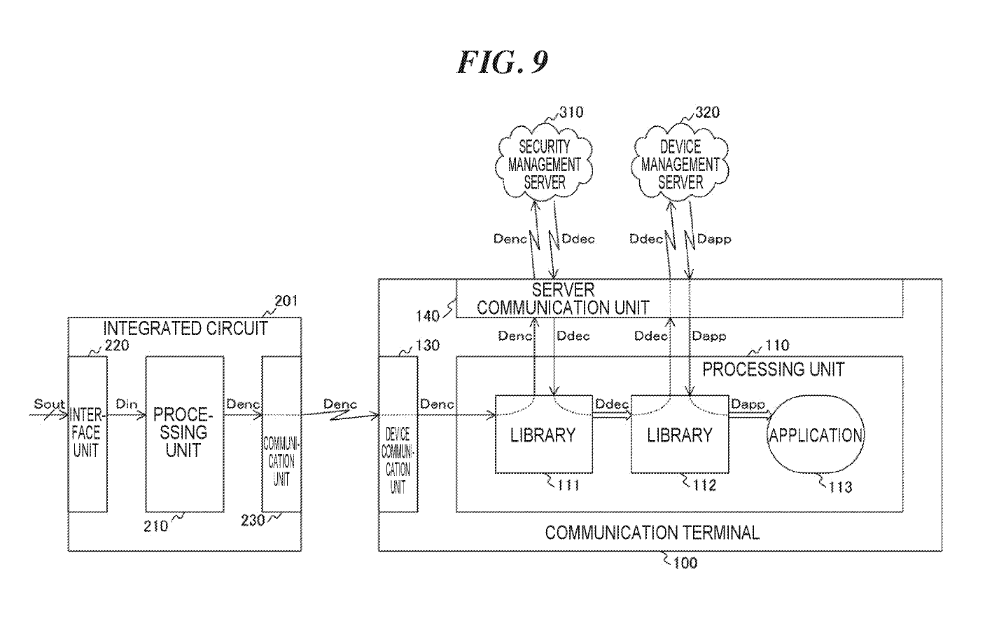

FIG. 9 is a diagram showing an example of a path of data along which data is transmitted from the electronic device 200 to the communication terminal 100 in a second embodiment of the present invention. In the second embodiment, when the library 111 accesses the security management server 310, data is encrypted or decrypted.

An analog or digital output signal Sout fed from the main circuit board 202 is converted by the interface unit 220 into digital data Din, which can be processed by the processing unit 210. The digital data Din is fed to the processing unit 210.

The digital data Din fed from the interface unit 220 is encrypted using a predetermined cryptographic key by the processing unit 210, and encrypted data Denc is generated. The encrypted data Denc encrypted by the processing unit 210 is transmitted to the communication terminal 100 by the communication unit 230.

The encrypted data Denc transmitted from the electronic device 200 is received by the device communication unit 130, and fed to the library 111. The encrypted data Denc fed to the library 111 is transmitted to the security management server 310 by the server communication unit 140.

The encrypted data Denc transmitted to the security management server 310 is decrypted using the predetermined cryptographic key by the security management server 310, and decrypted data Ddec is generated. The decrypted data Ddec decrypted by the security management server 310 is transmitted to the communication terminal 100.

The decrypted data Ddec transmitted to the communication terminal 100 is received by the server communication unit 140, and fed to the library 111. The decrypted data Ddec fed to the library 111 is further fed to the library 112. The decrypted data Ddec fed to the library 112 is transmitted to the device management server 320 by the server communication unit 140.

The decrypted data Ddec transmitted to the device management server 320 is converted into data Dapp in a format, in which data can be processed by the application 113 running on the communication terminal 100, on the basis of the information on the electronic device 200 by the device management server 320. The data Dapp converted by the device management server 320 is transmitted to the communication terminal 100.

The data Dapp transmitted from the device management server 320 is received by the server communication unit 140. The data Dapp received by the server communication unit 140 is fed to the library 112. The data Dapp fed to the library 112 is fed to the application 113.

As mentioned above, when data is transmitted from the electronic device 200 to the communication terminal 100 in the second embodiment, the processing unit 210 of the electronic device 200 encrypts the data so as to generate the encrypted data Denc. In response to access from the library 111, the security management server 310 decrypts the encrypted data Denc so as to generate the decrypted data Ddec. The device management server 320 converts the decrypted data Ddec into the data Dapp in a format, in which data can be processed by the application 113.

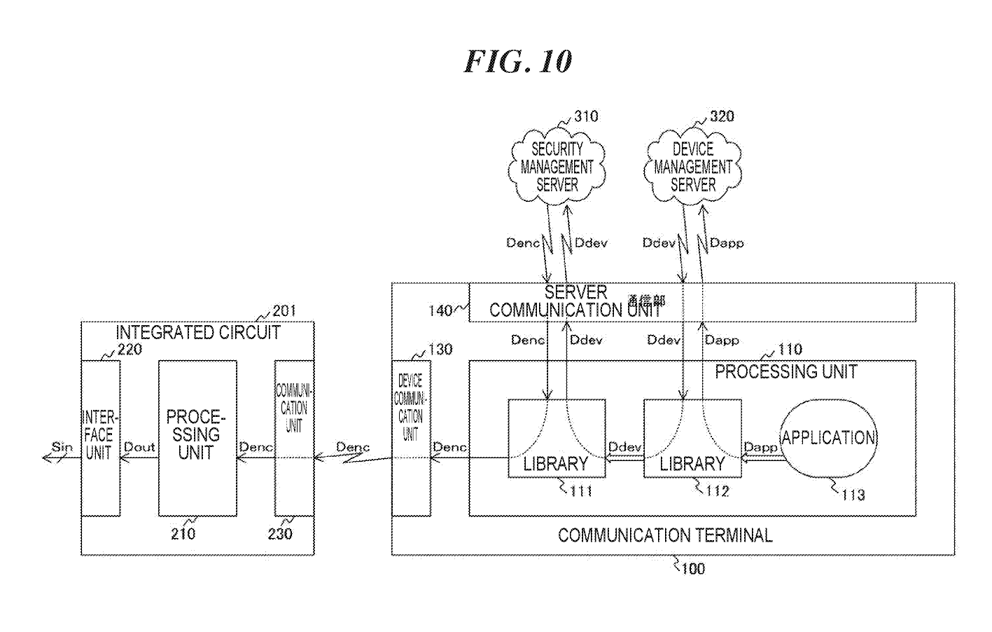

FIG. 10 is a diagram showing an example of a path of data along which data is transmitted from the communication terminal 100 to the electronic device 200 in the second embodiment of the present invention.

Data Dapp generated by the application 113 is fed to the library 112. The data Dapp fed to the library 112 is transmitted to the device management server 320 by the server communication unit 140.

The data Dapp transmitted to the device management server 320 is converted by the device management server 320 into data Ddev in a format, in which data can be processed by the electronic device 200. The data Ddev converted by the device management server 320 is transmitted to the communication terminal 100.

The data Ddev transmitted from the device management server 320 is received by the server communication unit 140. The data Ddev received by the server communication unit 140 is fed to the library 112. The data Ddev fed to the library 112 is further fed to the library 111. The data Ddev fed to the library 111 is transmitted to the security management server 310 by the server communication unit 140.

The data Ddev transmitted to the security management server 310 is encrypted using the predetermined cryptographic key by the security management server 310, and encrypted data Denc is generated. The encrypted data Denc encrypted by the security management server 310 is transmitted to the communication terminal 100.

The encrypted data Denc transmitted from the security management server 310 is received by the server communication unit 140. The encrypted data Denc received by the server communication unit 140 is fed to the library 111. The encrypted data Denc fed to the library 111 is transmitted to the electronic device 200 via the device communication unit 130.

The encrypted data Denc transmitted to the electronic device 200 is received by the communication unit 230. The encrypted data Denc received by the communication unit 230 is fed to the processing unit 210. The encrypted data Denc fed to the processing unit 210 is decrypted using the predetermined cryptographic key by the processing unit 210, and digital data Dout is generated. The digital data Dout decrypted by the processing unit 210 is fed to the interface unit 220.

The digital data Dout fed to the interface unit 220 is converted into an analog or digital input signal Sin for the main circuit board 202 by the interface unit 220. The converted analog or digital input signal Sin is fed to the main circuit board 202.

As mentioned above, when data is transmitted from the communication terminal 100 to the electronic device 200 in the second embodiment, the device management server 320 converts the data into the data Ddev in a format, in which data can be processed by the electronic device 200, in response to access from the library 112. The security management server 310 encrypts the converted data Ddev so as to generate the encrypted data Denc, in response to access from the library 111. The encrypted data Denc is fed to the electronic device 200 via the communication terminal 100. The processing unit 210 decrypts the encrypted data Denc so as to generate the digital data Dout. The digital data Dout is converted into the input signal Sin for the main circuit board 202 by the interface unit 220.

As mentioned above, according to the second embodiment, the communication terminal 100 uses the library 111 to request the security management server 310 to encrypt or decrypt data, whereby the data can be safely transmitted or received between the electronic device 200 and the communication terminal 100.

### Third Embodiment

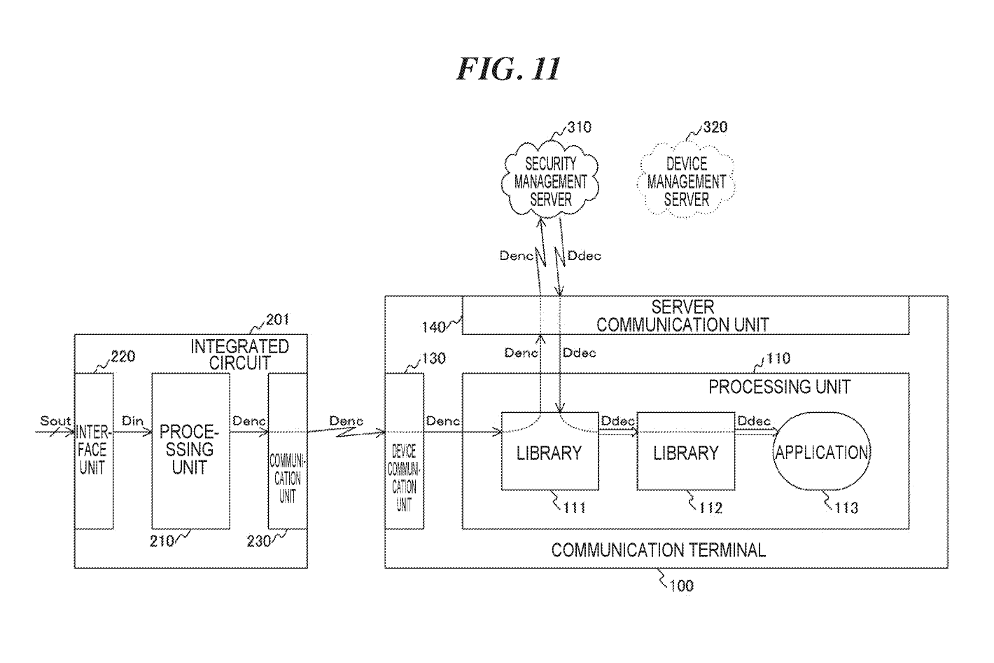

FIG. 11 is a diagram showing an example of a path of data along which data is transmitted from the electronic device 200 to the communication terminal 100 in a third embodiment of the present invention. In the third embodiment, similarly to the second embodiment, when the library 111 accesses the security management server 310, data is encrypted or decrypted. However, it is preconditioned that conversion by the device management server 320 is not carried out. Therefore, access to the device management server 320 from the library 112 does not take place.

In the third embodiment, since the same activities as those in the second embodiment are performed until decrypted data Ddec is fed from the library 111 to the library 112, an iterative description will be omitted. The decrypted data Ddec fed to the library 112 is then fed to the application 113.

As mentioned above, when data is transmitted from the electronic device 200 to the communication terminal 100 in the third embodiment, the processing unit 210 of the electronic device 200 encrypts the data so as to generate the encrypted data Denc. In response to access from the library 111, the security management server 310 decrypts the encrypted data Denc so as to generate the decrypted data Ddec. However, conversion into the data Dapp is not performed by the device management server 320.

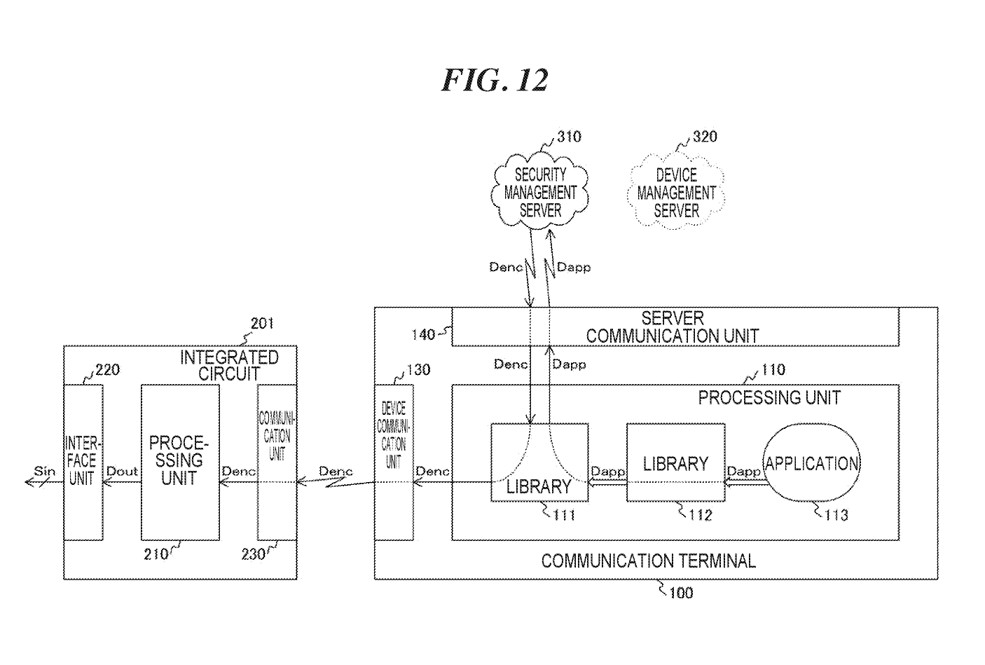

FIG. 12 is a diagram showing an example of a path of data along which data is transmitted from the communication terminal 100 to the electronic device 200 in the third embodiment of the present invention.

Data Dapp generated by the application 113 is fed to the library 112. The data Dapp fed to the library 112 is further fed to the library 111. The data Dapp fed to the library 111 is transmitted to the security management server 310 by the server communication unit 140.

The data Dapp transmitted to the security management server 310 is encrypted using a predetermined cryptographic key by the security management server 310, and encrypted data Denc is generated. The encrypted data Denc encrypted by the security management server 310 is transmitted to the communication terminal 100. Since the subsequent activities are identical to those in the second embodiment, an iterative description will be omitted.

As mentioned above, when data is transmitted from the communication terminal 100 to the electronic device 200 in the third embodiment, the security management server 310 encrypts the data so as to generate the encrypted data Denc, in response to access from the library 111. However, conversion into the data Ddev is not performed by the device management server 320. The encrypted data Denc is fed to the electronic device 200 via the communication terminal 100. The processing unit 210 decrypts the encrypted data Denc so as to generate the digital data Dout. The digital data Dout is converted into the input signal Sin for the main circuit board 202 by the interface unit 220.

As mentioned above, according to the third embodiment, the communication terminal 100 uses the library 111 to request the security management server 310 to encrypt or decrypt data, whereby the data can be safely transmitted or received between the electronic device 200 and the communication terminal 100. In the third embodiment, data conversion is not performed by the device management server 320. The third embodiment can therefore be applied to a case where such conversion is unnecessary.

### Fourth Embodiment

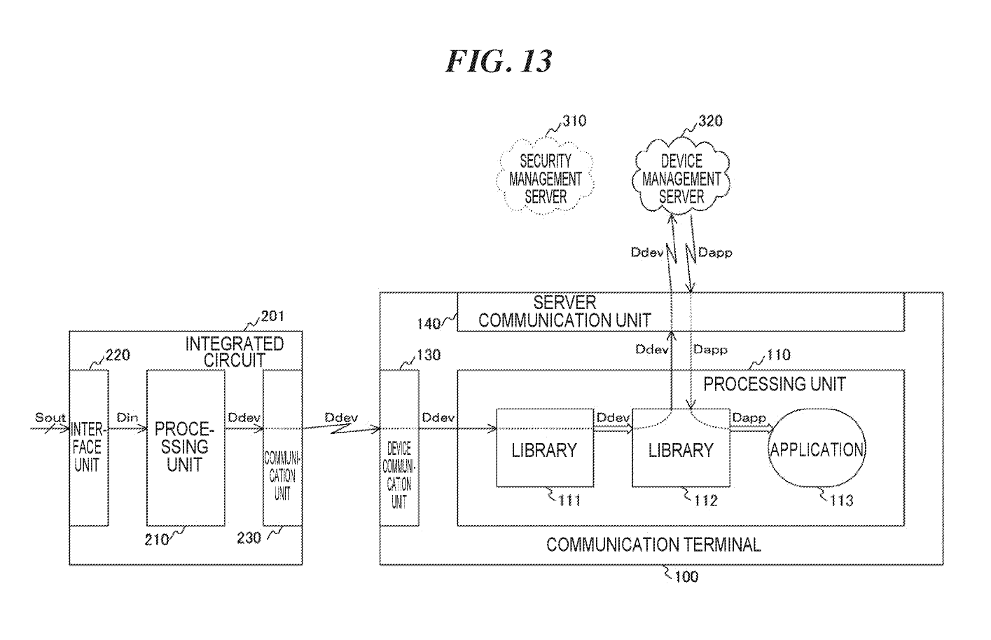

FIG. 13 is a diagram showing an example of a path of data along which data is transmitted from the electronic device 200 to the communication terminal 100 in a fourth embodiment of the present invention. In the fourth embodiment, data conversion is performed by the device management server 320, but encryption is not performed. Therefore, although plaintext data is transmitted or received between the communication terminal 100 and the electronic device 200, since the data is transmitted or received in a data format in which data can be interpreted only by the electronic device 200, security can be ensured to some extent.

An analog or digital output signal Sout fed from the main circuit board 202 is converted by the interface unit 220 into digital data Din, which can be processed by the processing unit 210. The digital data Din is fed to the processing unit 210.

The digital data Din fed from the interface unit 220 is not encrypted by the processing unit 210 but outputted as data Ddev. The data Ddev outputted from the processing unit 210 is transmitted to the communication terminal 100 by the communication unit 230.

The data Ddev transmitted from the electronic device 200 is received by the device communication unit 130, and fed to the library 111. The data Ddev fed to the library 111 is further fed to the library 112. The data Ddev fed to the library 112 is transmitted to the device management server 320 by the server communication unit 140.

The data Ddev transmitted to the device management server 320 is converted into data Dapp in a format, in which data can be processed by the application 113 running on the communication terminal 100, on the basis of the information on the electronic device 200 by the device management server 320. The data Dapp converted by the device management server 320 is transmitted to the communication terminal 100.

The data Dapp transmitted from the device management server 320 is received by the server communication unit 140. The data Dapp received by the server communication unit 140 is fed to the library 112. The data Dapp fed to the library 112 is fed to the application 113.

As mentioned above, when data is transmitted from the electronic device 200 to the communication terminal 100 in the fourth embodiment, the device management server 320 converts the data Ddev into the data Dapp in a format, in which data can be processed by the application 113.

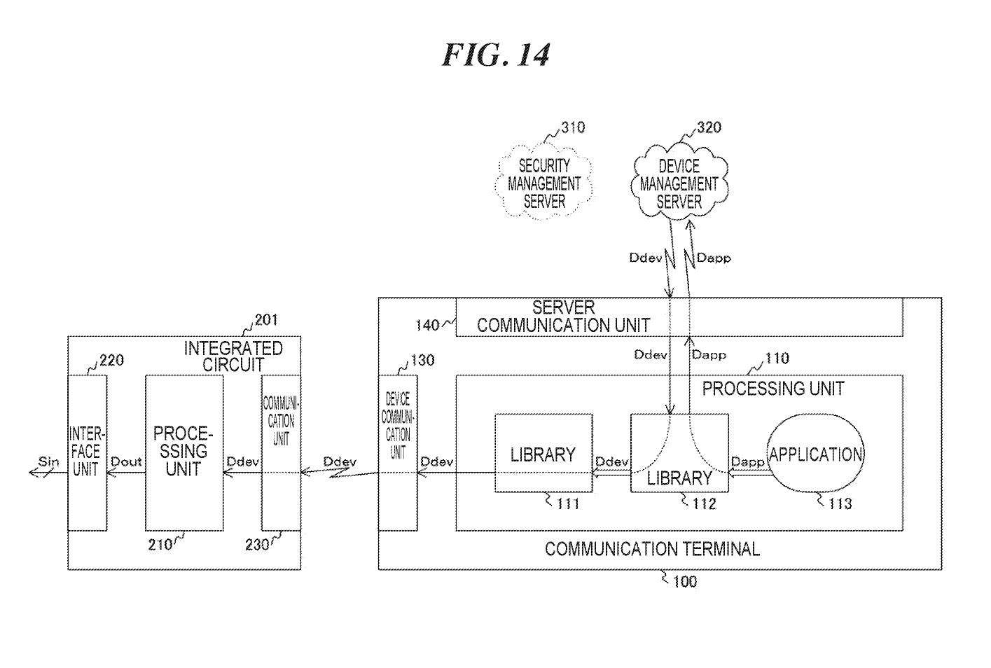

FIG. 14 is a diagram showing an example of a path of data along which data is transmitted from the communication terminal 100 to the electronic device 200 in the fourth embodiment of the present invention.

Data Dapp generated by the application 113 is fed to the library 112. The data Dapp fed to the library 112 is transmitted to the device management server 320 by the server communication unit 140.

The data Dapp transmitted to the device management server 320 is converted by the device management server 320 into data Ddev in a format, in which data can be processed by the electronic device 200. The data Ddev converted by the device management server 320 is transmitted to the communication terminal 100.

The data Ddev transmitted from the device management server 320 is received by the server communication unit 140. The data Ddev received by the server communication unit 140 is fed to the library 112. The data Ddev fed to the library 112 is further fed to the library 111. The data Ddev fed to the library 111 is transmitted to the electronic device 200 via the device communication unit 130.

The data Ddev transmitted to the electronic device 200 is received by the communication unit 230. The data Ddev received by the communication unit 230 is fed to the processing unit 210. The data Ddev fed to the processing unit 210 is plaintext data, therefore need not be decrypted, and is outputted as digital data Dout as it is. The digital data Dout outputted from the processing unit 210 is fed to the interface unit 220.

The digital data Dout fed to the interface unit 220 is converted into an analog or digital input signal Sin for the main circuit board 202 by the interface unit 220. The converted analog or digital input signal Sin is fed to the main circuit board 202.

As mentioned above, when data is transmitted from the communication terminal 100 to the electronic device 200 in the fourth embodiment, the device management server 320 converts the data Dapp into the data Ddev in a format, in which data can be processed by the electronic device 200.

As mentioned above, in the fourth embodiment, plaintext data is transmitted or received between the communication terminal 100 and the electronic device 200. However, since data to be transmitted from the electronic device 200 has a data format in which data can be interpreted only by the electronic device 200, when conversion by the device management server 320 is needed, security can be ensured to some extent.

The aforesaid embodiments are examples for embodying the present invention. Matters in the embodiments have correspondence to matters specifying the claimed invention. Likewise, the matters specifying the claimed invention have correspondence to the matters having the same names in the embodiments of the present invention. However, the present invention is not limited to the embodiments, but can be modified in various manners without a departure from the gist of the invention.

The electronic device 200 may merely have the capability to wirelessly communicate with the communication terminal 100. The electronic device 200 need not include a combination of the main circuit board 202 and the integrated circuit 201 as shown in the embodiments.

A part equivalent to the main circuit board 202 need not be an ordinary electric product. For example, open/close data of a door may be transmitted from an open/close sensor, which is attached to the door of a wine cellar or the like, to the communication terminal 100 via the processing unit 210 and the communication unit 230. In addition, for example, data stored in advance in a volatile or nonvolatile memory may be transmitted to the communication terminal 100 via the processing unit 210 and the communication unit 230. Thus, the electronic device 200 may be a quite simple circuit or module (for example, the open/close senor or the memory) provided with a wireless communication capability.

As the communication terminal, a terminal that has a wireless communication capability and can run an application, such as, a smartphone, a tablet terminal, a personal digital assistant (PDA), or a notebook PC is generally conceived. As a protocol for wireless communication, a communications standard for short-range wireless communication such as Bluetooth (registered trademark) or Bluetooth Low Energy, or a communications standard for a wireless LAN such as Wi-Fi (registered trademark) is conceivable. However, the present invention is not limited to the communications standard.

The processing sequence in the aforesaid embodiments may be regarded as a method including the series of steps. Otherwise, the processing sequence may be regarded as a program allowing a computer to execute the series of steps or a recording medium that stores the program. As the recording medium, for example, a compact disc (CD), a minidisc (MD), a digital versatile disc (DVD), a memory card, or a Blu-ray (registered trademark) disc may be adopted.

### REFERENCE SIGNS LIST

100: communication terminal,

110: processing unit,

111, 112: library,

113: application,

120: memory unit,

130: device communication unit,

140: server communication unit,

150: input unit,

160: output unit,

180: bus,

200: electronic device,

201: integrated circuit,

202: main circuit board,

210: processing unit,

220: interface unit,

230: communication unit,

300: cloud service,

310: security management server,

320: device management server,

410, 430: network,

420: gateway,

440, 450: base station.

1. A wireless communication system comprising:
an electronic device having a short-range wireless communication capability;
a communication terminal that performs the short-range wireless communication with the electronic device and operates the electronic device; and
a security management server that is connected to a network and manages security of data which is transmitted or received between the electronic device and the communication terminal, wherein:
the electronic device transmits data, which is encrypted using a predetermined cryptographic key, to the communication terminal through the short-range wireless communication, and decrypts data, which is transmitted from the communication terminal through the short-range wireless communication, using the predetermined cryptographic key;
the security management server encrypts or decrypts data, which is transmitted from the communication terminal over the network, using the predetermined cryptographic key, and transmits the data to the communication terminal over the network; and
the communication terminal transfers encrypted data to or from the electronic device through the short-range wireless communication, and requests the security management server to encrypt or decrypt data over the network.

2. The wireless communication system according to claim 1, wherein:
when data is transmitted from the electronic device to the communication terminal,
the electronic device encrypts first plaintext data using the predetermined cryptographic key, and transmits first encrypted data to the communication terminal through the short-range wireless communication,
the communication terminal receives the first encrypted data transmitted from the electronic device through the short-range wireless communication, and transmits the first encrypted data to the security management server over the network,
the security management server receives the first encrypted data transmitted from the communication terminal over the network, decrypts the first encrypted data using the predetermined cryptographic key, and transmits first decrypted data to the communication terminal over the network, and
the communication terminal receives the first decrypted data transmitted from the security management server over the network, and feeds the first decrypted data to an application running on the communication terminal; and
when data is transmitted from the communication terminal to the electronic device,
the communication terminal transmits second plaintext data, which is generated by the application, to the security management server over the network,
the security management server receives the second plaintext data transmitted from the communication terminal over the network, encrypts the second plaintext data using the predetermined cryptographic key, and transmits second encrypted data to the communication terminal over the network,
the communication terminal receives the second encrypted data transmitted from the security management server over the network, and transmits the second encrypted data to the electronic device through the short-range wireless communication, and
the electronic device receives the second encrypted data transmitted from the communication terminal through the short-range wireless communication, and decrypts the second encrypted data using the predetermined cryptographic key so as to generate second decrypted data.

3. The wireless communication system according to claim 1, further comprising a device management server that is connected to the network and manages information on the electronic device, wherein:
when data is transmitted from the electronic device to the communication terminal,
the electronic device encrypts first plaintext data using the predetermined cryptographic key, and transmits first encrypted data to the communication terminal through the short-range wireless communication,
the communication terminal receives the first encrypted data transmitted from the electronic device through the short-range wireless communication, and transmits the first encrypted data to the device management server over the network,
the device management server receives the first encrypted data transmitted from the communication terminal over the network, and transmits the first encrypted data to the security management server,
the security management server receives the first encrypted data transmitted from the device management server, decrypts the first encrypted data using the predetermined cryptographic key, and transmits first decrypted data to the device management server,
the device management server receives the first decrypted data transmitted from the security management server, converts the first decrypted data into a format, in which data can be processed by an application running on the communication terminal, on the basis of the information on the electronic device, and transmits first converted data to the communication terminal over the network, and
the communication terminal receives the first converted data transmitted from the device management server over the network and feeds the first converted data to the application; and
when data is transmitted from the communication terminal to the electronic device,
the communication terminal transmits second plaintext data, which is generated by the application, to the device management server over the network,
the device management server receives the second plaintext data transmitted from the communication terminal over the network, converts the second plaintext data into a format, in which data can be processed by the electronic device, on the basis of the information on the electronic device, and transmits second converted data to the security management server,
the security management server receives the second converted data transmitted from the device management server, encrypts the second converted data using the predetermined cryptographic key, and transmits second encrypted data to the device management server,
the device management server receives the second encrypted data transmitted from the security management server, and transmits the second encrypted data to the communication terminal over the network,
the communication terminal receives the second encrypted data transmitted from the device management server over the network, and transmits the second encrypted data to the electronic device through the short-range wireless communication, and
the electronic device receives the second encrypted data transmitted from the communication terminal, and decrypts the second encrypted data using the predetermined cryptographic key so as to generate second decrypted data.

4. The wireless communication system according to claim 1, further comprising a device management server that is connected to the network and manages information on the electronic device, wherein:
when data is transmitted from the electronic device to the communication terminal,
the electronic device encrypts first plaintext data using the predetermined cryptographic key, and transmits first encrypted data to the communication terminal through the short-range wireless communication,
the communication terminal receives the first encrypted data transmitted from the electronic device through the short-range wireless communication, and transmits the first encrypted data to the security management server over the network,
the security management server receives the first encrypted data transmitted from the communication terminal over the network, decrypts the first encrypted data using the predetermined cryptographic key, and transmits first decrypted data to the communication terminal over the network,
the communication terminal receives the first decrypted data transmitted from the security management server over the network, and transmits the first decrypted data to the device management server over the network,
the device management server receives the first decrypted data transmitted from the communication terminal over the network, converts the first decrypted data into a format, in which data can be processed by an application running on the communication terminal, on the basis of the information on the electronic device, and transmits first converted data to the communication terminal over the network, and
the communication terminal receives the first converted data transmitted from the device management server over the network, and feeds the first converted data to the application; and
when data is transmitted from the communication terminal to the electronic device,
the communication terminal transmits second plaintext data, which is generated by the application, to the device management server over the network,
the device management server receives the second plaintext data transmitted from the communication terminal over the network, converts the second plaintext data into a format, in which data can be processed by the electronic device, on the basis of the information on the electronic device, and transmits second converted data to the communication terminal over the network,
the communication terminal receives the second converted data transmitted from the device management server over the network, and transmits the second converted data to the security management server over the network,
the security management server receives the second converted data transmitted from the communication terminal over the network, encrypts the second converted data using the predetermined cryptographic key, and transmits second encrypted data to the communication terminal over the network,
the communication terminal receives the second encrypted data transmitted from the security management server over the network, and transmits the second encrypted data to the electronic device through the short-range wireless communication, and
the electronic device receives the second encrypted data transmitted from the communication terminal through the short-range wireless communication, and decrypts the second encrypted data using the predetermined cryptographic key so as to generate second decrypted data.

5-10. (canceled)

11. A wireless communication method in a wireless communication system including an electronic device that has a short-range wireless communication capability, a communication terminal that performs the short-range wireless communication with the electronic device and operates the electronic device, and a security management server that is connected to a network and manages security of data which is transmitted or received between the electronic device and the communication terminal, comprising the steps of:
allowing the electronic device to transmit data, which is encrypted using a predetermined cryptographic key, to the communication terminal through the short-range wireless communication;
allowing the electronic device to decrypt data, which is transmitted from the communication terminal through the short-range wireless communication, using the predetermined cryptographic key;
allowing the communication terminal to transfer encrypted data to or from the electronic device through the short-range wireless communication;
allowing the communication terminal to request the security management server to encrypt or decrypt data using the predetermined cryptographic key over the network; and
allowing the security management server to encrypt or decrypt data, which is transmitted from the communication terminal over the network, using the predetermined cryptographic key and to transmit the data to the communication terminal over the network.

12. (canceled)

13. The wireless communication system according to claim 2, wherein:
the communication terminal includes
a device communication unit that performs the short-range wireless communication with the electronic device,
a server communication unit that communicates with the security management server over the network, and
a processing unit that controls communications of the device communication unit and the server communication unit, and runs the application;
the device communication unit receives the first encrypted data from the electronic device and transmits the second encrypted data to the electronic device; and
the server communication unit transmits the first encrypted data to the security management server and receives the first decrypted data from the security management server, and transmits the second plaintext data to the security management server and receives the second encrypted data from the security management server.

14. The wireless communication system according to claim 3, wherein:
the communication terminal includes
a device communication unit that performs the short-range wireless communication with the electronic device,
a server communication unit that communicates with the device management server over the network, and
a processing unit that controls communications of the device communication unit and the server communication unit, and runs the application;
the device communication unit receives the first encrypted data from the electronic device and transmits the second encrypted data to the electronic device; and
the server communication unit transmits the first encrypted data to the device management server and receives the first converted data from the device management server, and transmits the second plaintext data to the device management server and receives the second encrypted data from the device management server.

15. The wireless communication system according to claim 4, wherein:
the communication terminal includes
a device communication unit that performs the short-range wireless communication with the electronic device,
a server communication unit that communicates with the security management server and the device management server over the network, and
a processing unit that controls communications of the device communication unit and the server communication unit, and runs the application;
the device communication unit receives the first encrypted data from the electronic device and transmits the second encrypted data to the electronic device; and
the server communication unit transmits the first encrypted data to the security management server and receives the first decrypted data from the security management server, transmits the first decrypted data to the device management server and receives the first converted data from the device management server, transmits the second plaintext data to the device management server and receives the second converted data from the device management server, and transmits the second converted data to the security management server and receives the second encrypted data from the security management server.
